(19) United States
(12) Patent Application Publication
(10) Pub. No.: US 2025/0226454 A1
(43) Pub. Date: Jul. 10, 2025

(54) CYLINDRICAL NONAQUEOUS ELECTROLYTE SECONDARY BATTERY

(71) Applicant: Panasonic Energy Co., Ltd., Osaka (JP)

(72) Inventors: Katsumasa MATSUMOTO, Hyogo (JP); Shunsuke NAMBUYA, Osaka (JP); Shinya KITAHAMA, Hyogo (JP)

(21) Appl. No.: 18/838,695

(22) PCT Filed: Feb. 10, 2023
(86) PCT No.: PCT/JP2023/004490

§ 371 Date: Aug. 15, 2024

(30) Foreign Application Priority Data
Feb. 28, 2022 (JP) 2022-028851

(51) Int. Cl. H01M 10/0587

(52) U.S. Cl. CPC H01M 10/0587

(57) ABSTRACT

A cylindrical nonaqueous electrolyte secondary battery according to the present invention is provided with: a wound electrode body which is obtained by winding a positive electrode and a negative electrode with a separator being interposed therebetween; a nonaqueous electrolyte; and an outer package can in which the electrode body and the nonaqueous electrolyte are contained. The negative electrode has a bent part, which is bent toward the inner winding side, at a position that is closer to the winding start point than a facing part which faces a leading end part of the positive electrode on the inner winding side of the leading end part. This nonaqueous electrolyte secondary battery can suppress deformation of the negative electrode toward the leading end part of the positive electrode, thereby achieving good cycle characteristics.

### TECHNICAL FIELD

The present disclosure relates to a cylindrical non-aqueous electrolyte secondary battery.

### BACKGROUND ART

PATENT LITERATURE 1 discloses a conventional cylindrical non-aqueous electrolyte secondary battery. In this non-aqueous electrolyte secondary battery, a negative electrode having negative electrode mixture layers has a non-facing portion that does not face a positive electrode on the inner winding side of an electrode assembly, and the non-facing portion exists greater than or equal to two rounds. The non-aqueous electrolyte secondary battery restrains deformation of the electrode assembly on the inner winding side by providing the aforementioned non-facing portion on the inner winding side.

### CITATION LIST

### Patent Literature

PATENT LITERATURE 1: Japanese Unexamined Patent Application Publication No. 2013-137946

### SUMMARY

In a cylindrical non-aqueous electrolyte secondary battery, there is occasionally a case where the positive electrode and the negative electrode expand and contract under repetition of charge and discharge, a negative electrode portion positioned at a positive electrode starting end on the inner winding side deforms and comes close to the positive electrode starting end side. The negative electrode coming close to the positive electrode starting end side as above causes a concern that the distance between the positive electrode and the negative electrode varies, the charge and discharge reactions become uneven, and cycle characteristics deteriorate. It is therefore an advantage of the present disclosure to provide a cylindrical non-aqueous electrolyte secondary battery capable of restraining a negative electrode from coming close to a positive electrode starting end side and capable of attaining excellent cycle characteristics.

In order to solve the aforementioned problem, there is provided a cylindrical non-aqueous electrolyte secondary battery according to the present disclosure, comprising: an electrode assembly having a positive electrode and a negative electrode wound via a separator; a non-aqueous electrolyte; and an exterior can that houses the electrode assembly and the non-aqueous electrolyte, wherein the negative electrode has a bent portion that is bent to an inner winding side, more on a winding starting side than a facing portion that faces a starting end of the positive electrode on the inner winding side of the starting end.

According to the cylindrical non-aqueous electrolyte secondary battery according to the present disclosure, since the negative electrode can be restrained from coming close to the positive electrode starting end side, charge and discharge reactions become uniform, and excellent cycle characteristics can be attained.

### BRIEF DESCRIPTION OF DRAWINGS

FIG. 1 is an axial sectional view of a cylindrical non-aqueous electrolyte secondary battery according to an embodiment of the present disclosure.

FIG. 2 is a perspective view of an electrode assembly of the non-aqueous electrolyte secondary battery.

FIG. 3 is a plan view showing a winding structure of the inner winding side in the electrode assembly.

FIG. 4 is an expanded plan view of a starting end of a positive electrode and its periphery in FIG. 3.

FIG. 5 is a plan view showing a winding structure of the inner winding side in an electrode assembly of a cylindrical non-aqueous electrolyte secondary battery of a comparative example.

FIG. 6 is an expanded plan view of a starting end of a positive electrode and its periphery in FIG. 5.

### DESCRIPTION OF EMBODIMENTS

Hereafter, embodiments of a cylindrical non-aqueous electrolyte secondary battery according to the present disclosure will be described in detail with reference to the drawings. It is originally supposed to combine properly characteristic portions of the embodiments and the modifications hereafter described to construct a new embodiment. In the embodiments below, the same configurations in the drawings are given the same signs, and their duplicate description is omitted. Moreover, the drawings include some schematic diagrams, and proportions of dimensions such as lengths, widths, and depths of components do not necessarily coincide with one another between different drawings. Moreover, in the present specification, a sealing assembly 17 side of a cylindrical non-aqueous electrolyte secondary battery 10 in the axial direction (height direction) is regarded as being on the “upside”, and a bottom 68 side of an exterior can 16 in the axial direction is regarded as being on the “downside”. Among the constituent components described below, constituent components that are not disclosed in the independent claim indicating the highest concept are optional constituent components, not the essential constituent components. Moreover, the present disclosure is not limited to the embodiment and its modifications below, and various improvements and alterations may occur without departing from the scope of the matters disclosed in the claims of the present application and their equivalents.

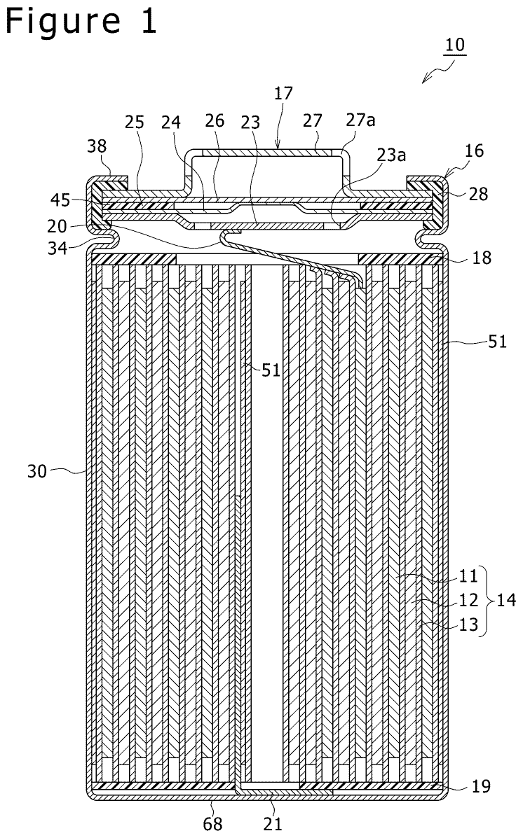

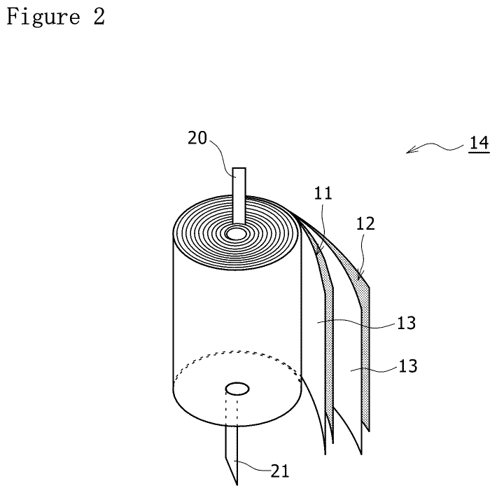

FIG. 1 is an axial sectional view of the cylindrical non-aqueous electrolyte secondary battery 10 according to an embodiment of the present disclosure, and FIG. 2 is a perspective view of an electrode assembly 14 of the non-aqueous electrolyte secondary battery 10. First, using FIG. 1 and FIG. 2, a basic configuration of the non-aqueous electrolyte secondary battery 10 is described. As shown in FIG. 1, the non-aqueous electrolyte secondary battery (hereinafter simply referred to as battery) 10 comprises the winding-type electrode assembly 14, a non-aqueous electrolyte (not shown), the bottomed tubular metal-made exterior can 16 housing the electrode assembly 14 and the non-aqueous electrolyte, and the sealing assembly 17 closing an opening of the exterior can 16. As shown in FIG. 2, the electrode assembly 14 has a winding structure having a long strip-shaped positive electrode 11 and a long strip-shaped negative electrode 12 wound via two long strip-shaped separators 13.

In order to prevent precipitation of lithium, the negative electrode 12 is formed to be larger by a certain size than the positive electrode 11. Namely, the negative electrode 12 is formed to be longer than the positive electrode 11 in a longitudinal direction and a width direction (transverse direction). Moreover, the two separators 13 are formed at least to be larger by a certain size than the positive electrode 11 and, for example, are arranged such that the positive electrode 11 is interposed therebetween. The negative electrode 12 may constitute a winding starting end of the electrode assembly 14. Nevertheless, the separators 13 generally extend beyond an end of the negative electrode 12 on the winding starting side, and ends of the separators 13 on the winding starting side constitute the winding starting end of the electrode assembly 14.

The non-aqueous electrolyte includes a non-aqueous solvent and an electrolyte salt dissolved in the non-aqueous solvent. For the non-aqueous solvent, for example, there may be used esters, ethers, nitriles, amides, a mixed solvent of two kinds or more of these, and the like. The non-aqueous solvent may contain a halogen-substituted substance having halogen atom(s) such as fluorine substituted for at least part of hydrogen atoms of these solvents. Notably, the non-aqueous electrolyte is not limited to a liquid electrolyte and may be a solid electrolyte using a gelatinous polymer or the like. For the electrolyte salt, a lithium salt such as LiPF₆ is used.

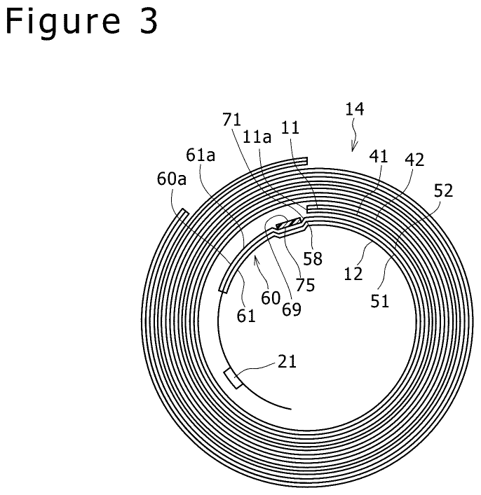

The positive electrode 11 has a positive electrode core 41 (refer to FIG. 3) and positive electrode mixture layers 42 (refer to FIG. 3) formed on both surfaces of the positive electrode core 41. For the positive electrode core 41, there can be used foil of a metal, such as aluminum or aluminum alloy, that is stable in the potential range of the positive electrode 11, a film having the metal disposed in the surface layer, and the like. The positive electrode mixture layers 42 include a positive electrode active material, a conductive agent, and a binder agent. The positive electrode 11 can be produced, for example, by applying positive electrode mixture slurry including the positive electrode active material, the conductive agent, the binder agent, and the like on the positive electrode core 41, drying the coating film and afterward compressing it to form the positive electrode mixture layers 42 on both surfaces of the positive electrode core 41.

The positive electrode active material is composed of a lithium-containing metal composite oxide as a main component. Examples of a metal element contained in the lithium-containing metal composite oxide include Ni, Co, Mn, Al, B, Mg, Ti, V, Cr, Fe, Cu, Zn, Ga, Sr, Zr, Nb, In, Sn, Ta, W, and the like. A preferable example of the lithium-containing metal composite oxide is a composite oxide containing at least one of the group consisting of Ni, Co, Mn, and Al.

Examples of the conductive agent included in the positive electrode mixture layers 42 can include carbon materials such as carbon black, acetylene black, Ketjen black, and graphite. Examples of the binder agent included in the positive electrode mixture layers 42 can include fluorine resins such as polytetrafluoroethylene (PTFE) and polyvinylidene fluoride (PVdF), polyacrylonitrile (PAN), polyimide resins, acrylic resins, polyolefin resins, and the like. There may be used, together with these resins, cellulose derivatives such as carboxymethylcellulose (CMC) or its salt, polyethylene oxide (PEO), and the like.

The negative electrode 12 has a negative electrode core 51 (refer to FIG. 3) and negative electrode mixture layers 52 (refer to FIG. 3) formed on both surfaces of the negative electrode core 51. For the negative electrode core 51, there can be used foil of a metal, such as copper or copper alloy, that is stable in the potential range of the negative electrode 12, a film having the metal disposed in the surface layer, and the like. The negative electrode mixture layers 52 include a negative electrode active material and a binder agent. The negative electrode 12 can be produced, for example, by applying negative electrode mixture slurry including the negative electrode active material, the binder agent, and the like on the negative electrode core 51, drying the coating film and afterward compressing it to form the negative electrode mixture layers 52 on both surfaces of the negative electrode core 51.

For the negative electrode active material, there is generally used a carbon material that reversibly stores and releases lithium ions. Preferable examples of the carbon material include graphite such as natural graphite such as flaky graphite, massive graphite, and earthy graphite, and artificial graphite such as massive artificial graphite and graphitized mesophase carbon microbeads. The negative electrode mixture layers 52 may include, as the negative electrode active material, a Si material containing silicon (Si). Moreover, in this case, the negative electrode mixture layers 52 may include silicon oxide expressed as SiOₓ (0.5≤x≤1.6). Moreover, for the negative electrode active material, there may be used a metal, other than Si, that is alloyed with lithium, an alloy containing the metal, a compound containing the metal, and the like.

While, for the binder agent included in the negative electrode mixture layers 52, fluorine resins, PAN, polyimide resins, acrylic resins, polyolefin resins, and the like may be used as in the case of the positive electrode 11, there is preferably used styrene-butadiene rubber (SBR) or its modified substance. In the negative electrode mixture layers 52, for example, in addition to SBR or the like, there may be included CMC or its salt, polyacrylic acid (PAA) or its salt, polyvinyl alcohol, or the like.

For the separators 13, there are used porous sheets having ion permeability and insulation ability. Specific examples of the porous sheet include a microporous thin film, woven fabric, nonwoven fabric, and the like. For the material of the separators 13, there are preferably employed polyolefin resins such as polyethylene and polypropylene, cellulose, and the like. Each separator 13 may take any of a single layer structure and a stacked structure. A heat resistant layer and/or the like may be formed on a surface of the separator 13.

As shown in FIG. 1, a positive electrode lead 20 is joined to the positive electrode 11, and a negative electrode lead 21 is joined to a winding starting side of the negative electrode 12 in the longitudinal direction. The battery 10 has an insulating plate 18 on the upside of the electrode assembly 14 and an insulating plate 19 on the downside of the electrode assembly 14. The positive electrode lead 20 extends to the sealing assembly 17 side through a through hole of the insulating plate 18, and the negative electrode lead 21 extends to the bottom 68 side of the exterior can 16 through a through hole of the insulating plate 19. The positive electrode lead 20 is connected to a lower surface of a sealing plate 23 of the sealing assembly 17 by welding or the like. A terminal cap 27 constituting a top plate of the sealing assembly 17 is electrically connected to the sealing plate 23, and the terminal cap 27 works as a positive electrode terminal. Moreover, the negative electrode lead 21 is connected to an inner surface of the bottom 68 of the metal-made exterior can 16 by welding or the like, and the exterior can 16 works as a negative electrode terminal.

In the present embodiment, the positive electrode lead 20 is electrically connected to an intermediate portion such as a center portion of the positive electrode core 41 in a winding direction. Moreover, the negative electrode lead 21 is electrically connected to an end of the negative electrode core 51 on the winding starting side, and an end of the negative electrode core 51 on the winding finishing side is brought into contact with an inner surface of the exterior can 16. By electrically connecting both the winding starting side and the winding finishing side of the negative electrode 12 to the negative electrode terminal as above, paths where current flows are shortened, and an electric resistance is reduced. Nevertheless, not bringing the end of the negative electrode core 41 on the winding finishing side into contact with the inner surface of the exterior can, one negative electrode lead may be electrically connected to the end of the negative electrode core on the winding finishing side. Otherwise, the electrode assembly may have two negative electrode leads, one of the negative electrode leads may electrically connected to the end of the negative electrode core on the winding starting side, and the other of the negative electrode leads may be electrically connected to the end of the negative electrode core on the winding finishing side. Otherwise, the negative electrode and the exterior can may be electrically connected by bringing the end of the negative electrode core on the winding finishing side into contact with the inner surface of the exterior can, not using a negative electrode lead.

The battery 10 further comprises a resin-made gasket 28 arranged between the exterior can 16 and the sealing assembly 17. The sealing assembly 17 is crimped and fixed to the opening of the exterior can 16 via the gasket 28. Thereby, the inner space of the battery 10 is hermetically sealed. The gasket 28 is pinched and held by the exterior can 16 and the sealing assembly 17 and insulates the sealing assembly 17 from the exterior can 16. The gasket 28 has a role as a sealing material that keeps gastightness inside the battery and a role as an insulating material that insulates the exterior can 16 and the sealing assembly 17 from each other.

The exterior can 16 houses the electrode assembly 14 and the non-aqueous electrolyte, and has a shoulder 38, a grooved portion 34, a tubular portion 30, and the bottom 68. The grooved portion 34 can be formed, for example, by performing spinning processing on a part of the side wall of the exterior can 16 inward in a radial direction to recess it into an annular shape inward in the radial direction. The shoulder 38 is formed, when the sealing assembly 17 is crimped and fixed to the exterior can 16, by folding an upper end of the exterior can 16 inward toward a peripheral edge 45 of the sealing assembly 17.

The sealing assembly 17 has a structure in which the sealing plate 23, a lower vent member 24, an insulating member 25, an upper vent member 26, and the terminal cap 27 are stacked in the order from the electrode assembly 14 side. Each of the members constituting the sealing assembly 17 has a disc shape or a ring shape, for example, and the members except the insulating member 25 are electrically connected to one another. The sealing plate 23 has at least one through hole 23a. Moreover, the lower vent member 24 and the upper vent member 26 are connected at their center portions, and between their peripheral edges, the insulating member 25 is interposed.

When abnormal heat generation of the battery 10 occurs and an internal pressure of the battery 10 rises, the lower vent member 24 deforms so as to push the upper vent member 26 upward to the terminal cap 27 side and ruptures, and a current path between the lower vent member 24 and the upper vent member 26 is disconnected. When the internal pressure further rises, the upper vent member 26 ruptures and gas is discharged from a through hole 27a of the terminal cap 27. This discharge of the gas can prevent the internal pressure of the battery 10 from excessively rising and the battery 10 from blowing up, and safety of the battery 10 can be enhanced.

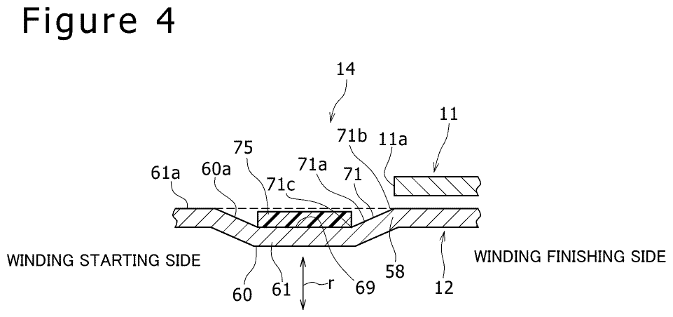

FIG. 3 is a plan view showing a winding structure of the inner winding side in the electrode assembly 14, and FIG. 4 is an expanded plan view of a starting end 11a of the positive electrode 11 and its periphery in FIG. 3. Notably, in FIG. 3, illustration of the separators is omitted. As shown in FIG. 3, the negative electrode 12 includes a non-facing portion 60 that does not face the positive electrode 11 and is wound to the winding starting side from a facing portion 58 that faces an inner winding side of the starting end 11a of the positive electrode 11 in the winding direction. Moreover, the non-facing portion 60 has a negative electrode mixture layer formation portion 61 having the negative electrode mixture layers 52 continuously provided along the winding direction on both surfaces of the negative electrode core 51.

As shown in FIG. 3 and FIG. 4, the negative electrode 12 has a bent portion 71 that is bent to the inner winding side, more on the winding starting side than the facing portion 58 that faces the starting end 11a of the positive electrode 11 on the inner winding side of the starting end 11a. The bent portion 71 is positioned more on the winding finishing side than a position of ¼ rounds from the facing portion 58 to the winding starting side on the negative electrode 12. Referring to FIG. 4, a difference in the radial direction (direction indicated by the arrow r in FIG. 4) of the electrode assembly 14 between an end 71b of the bent portion 71 on the winding finishing side on an outer winding surface 71a and an end 71c of the bent portion 71 on the winding starting side on the outer winding surface 71a is greater than or equal to 20 μm. As shown in FIG. 3 and FIG. 4, the battery 10 comprises a resin tape 75 that is pasted on an outer winding surface 60a of the non-facing portion 60 that does not face the positive electrode 11 on the negative electrode 12. An outer winding surface 61a of the negative electrode mixture layer formation portion 61 has a recess 69 that is recessed to the inner winding side. The resin tape 75 is pasted on a bottom surface of the recess 69. A thickness of the resin tape 75 is preferably greater than or equal to 20 μm and less than or equal to 400 μm. By pasting the resin tape 75, the shape of the bent portion 71 is readily kept.

According to the battery 10, the negative electrode 12 has the bent portion 71 bent to the inner winding side, more on the winding starting side than the facing portion 58. Accordingly, even when the positive electrode 11 and the negative electrode 12 expand and contract under repetition of charge and discharge and a force to the outer winding side acts on a peripheral portion of the facing portion 58 of the negative electrode 12, a negative electrode portion that is positioned on the inner winding side of the starting end 11a of the positive electrode 11 can be restrained from coming close to the starting end 11a side. Therefore, since a distance between the positive electrode and the negative electrode can be readily made a uniform distance regardless of the position in the winding direction, charge and discharge reactions become uniform in the winding direction, and excellent cycle characteristics of the battery can be attained.

The bent portion 71 is preferably positioned more on the winding finishing side than a position of ¼ rounds of winding from the facing portion 58 to the winding starting side. By the bent portion 71 being near the starting end 11a of the positive electrode 11 as above, the aforementioned effect is significantly exhibited. When the difference in the radial direction between the end 71b of the bent portion 71 on the outer winding side and the end 71c of the bent portion 71 on the inner winding side is greater than or equal to 20 μm, the negative electrode 12 can be securely restrained from coming close to the starting end 11a side. When the difference in the radial direction between the end 71b of the bent portion 71 on the outer winding side and the end 71c of the bent portion 71 on the inner winding side is less than or equal to 400 μm, a uniform distance between the positive electrode and the negative electrode in the winding direction is preferably readily attained.

Moreover, since the battery 10 comprises the resin tape 75 pasted on the outer winding surface 60a of the non-facing portion 60 that does not face the positive electrode 11 on the negative electrode 12, strength of the non-facing portion 60 can be increased. Therefore, the negative electrode 12 can be further securely prevented from coming close to the starting end 11a side of the positive electrode 11. Moreover, since a frictional coefficient of the resin tape 75 is small, a frictional force that the negative electrode 12 receives from the periphery of the starting end 11a of the positive electrode 11 can be reduced, and the negative electrode 12 can be restrained from deforming at the periphery of the starting end 11a. When the thickness of the resin tape 75 is greater than or equal to 20 μm, rigidity of the resin tape 75 can be made sufficient, and when the thickness of the resin tape 75 is less than or equal to 400 μm, the positive electrode 11, the negative electrode 12, and the two separators 13 can be smoothly wound in production of the electrode assembly 14.

### Example 1

### [Production of Positive Electrode]

One hundred pts. mass of a positive electrode active material having a composition of LiNi_{0.91}Co_{0.04}Al_{0.05}O₂, 1.0 pt. mass of acetylene black, and 0.9 pts. mass of polyvinylidene fluoride (PVDF) (binder agent) were mixed in a solvent of N-methylpyrrolidone (NMP) to prepare the positive electrode slurry. The obtained slurry was applied on both surfaces of Al current collector foil with a thickness of 20 μm, and after that, after NMP was removed at a temperature greater than or equal to 100° C. and less than or equal to 150° C. in a drying machine, compression was performed by a roll press machine. Furthermore, the positive electrode plate after the compression was cut to produce a positive electrode.

### [Production of Negative Electrode]

Eighty pts. mass of graphite powder, 20 pts. mass of Si oxide, 1 pt. mass of CMC, and 1 pt. mass of styrene-butadiene rubber were mixed and dispersed in water to prepare the negative electrode slurry. The negative electrode slurry was applied on both surfaces of a negative electrode core of copper foil with a thickness of 10 μm to form negative electrode mixture layers. Next, after the electrode plate was compressed with compression rollers and dried, it was cut thereby to produce a negative electrode.

### [Production of Wound Electrode Assembly]

By pressing, to the inner winding side, a region near a facing portion, the region being more on the winding starting side than the facing portion of the negative electrode that faced the starting end of the positive electrode on the inner winding side, there was reformed a part of the negative electrode toward the inner winding side to form a bent portion in the negative electrode. Moreover, the aforementioned recess that was recessed to the inner winding side was formed at the periphery of the bent portion of the negative electrode, and a resin tape was pasted on the bottom surface of the recess. The thickness of the resin tape was set to 150 μm. Moreover, the distance of the bent portion in the radial direction (depth of the recess) was set to 150 μm. After that, the negative electrode, the positive electrode, and two separators were wound by a winding machine to form a winding-shaped electrode assembly. Notably, by forming a flat portion on a part of the outer peripheral surface of the winding core of the winding machine, the bent portion (step) may be provided in a part of the negative electrode during the winding step. Moreover, the step may be provided by exerting a force on the negative electrode in pasting the resin tape.

### [Preparation of Non-Aqueous Electrolyte Solution]

To a mixed solvent composed of fluoroethylene carbonate (FEC) and dimethylmethyl carbonate (DMC) (FEC:DMC=1:3 in volume ratio), LiPF₆ was dissolved in 1.5 mole/liter to prepare a non-aqueous electrolyte solution.

### [Production of Battery]

Insulating plates were respectively arranged on the upside and the downside of the electrode assembly, a negative electrode lead was welded to a battery case, a positive electrode lead was welded to a sealing plate having an internal pressure-operational safety valve, and housing inside the circular-bottomed cylindrical battery case was performed. Moreover, the outermost peripheral surface of the electrode assembly was constituted of a negative electrode core exposed portion, and the negative electrode core exposed portion was brought into contact with the inner peripheral surface of the battery case. After that, the non-aqueous electrolyte solution was injected inside the battery case in a reduced pressure scheme. In the final stage, by crimping the opening end of the battery case onto the sealing assembly via a gasket, a cylindrical non-aqueous electrolyte secondary battery was produced. A diameter and a height of the battery were 18 mm and 65 mm, respectively. Moreover, the capacity of the battery was 3300 mAh.

### Example 2

A cylindrical non-aqueous electrolyte secondary battery was produced different from that of Example 1 only in that the thickness of the resin tape was 100 μm and the distance of the bent portion in the radial direction (depth of the recess) was 100 μm.

### Example 3

A cylindrical non-aqueous electrolyte secondary battery was produced different from that of Example 1 only in that the thickness of the resin tape was 20 μm and the distance of the bent portion in the radial direction (depth of the recess) was 20 μm.

### Example 4

A cylindrical non-aqueous electrolyte secondary battery was produced different from that of Example 1 only in that the distance of the bent portion in the radial direction (depth of the recess) was 20 μm and a resin tape was not pasted.

### Example 5

A cylindrical non-aqueous electrolyte secondary battery was produced different from that of Example 1 only in that the thickness of the resin tape was 400 μm and the distance of the bent portion in the radial direction (depth of the recess) was 380 μm.

### Comparative Example

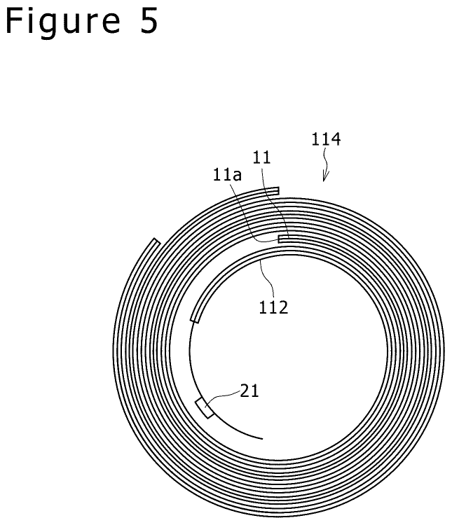

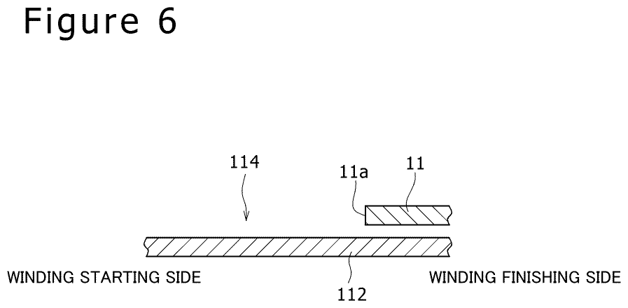

FIG. 5 is a plan view showing a winding structure of the inner winding side in an electrode assembly 114 of a cylindrical non-aqueous electrolyte secondary battery of Comparative Example, and FIG. 6 is an expanded plan view of the starting end 11a of the positive electrode 11 and its periphery in FIG. 5. The cylindrical non-aqueous electrolyte secondary battery was produced different from that of Example 1 only in that a bent portion was not provided in a negative electrode 112 of the electrode assembly and a resin tape was not pasted as shown in FIG. 5 and FIG. 6.

### [Cycle Test]

For each of the batteries of Examples 1 to 5 and Comparative Example, a cycle test was performed under the following conditions. First, each battery was charged at constant current-constant voltage (CC-CV) and was discharged at constant current (CC). In detail, on the produced battery, CC charging at 0.3C was performed in a 45° C. atmosphere until the voltage became 4.2 V. After that, CV charging at 4.2 V was performed until the current became 0.02C. Discharge was performed at a constant current of 0.2C until the voltage became 2.5 V. Moreover, a resting time after each of charge and discharge was set to 20 minutes. Three hundred cycles of cycle tests as above were performed, and a ratio (percentage) of the discharge capacity at the 300th cycle relative to the discharge capacity at the first cycle was calculated as a capacity retention

### [Measurement of Negative Electrode Step]

An X-ray CT image of the vicinity of the battery center portion (center portion of the wound electrode assembly) was acquired. The X-ray CT image was acquired using an X-ray CT apparatus (TOSCANER-32300mFD-Z2) manufactured by Toshiba Corporation. Based on the relevant X-ray CT, the bent portion of the negative electrode in the region not corresponding to the positive electrode was specified and the length of the bent portion in the radial direction was measured.

### [Test Results]

TABLE 1

| | | Resin | Bent Portion | Capacity |
|---|---|---|---|---|
| | Resin | Tape | Length in | Retention |
| | Tape | Thickness | Radial | After 300 |
| | Pasted | (μm) | Direction (μm) | Cycles (%) |
| Example 1 | Present | 150 | 150 | 84 |
| Example 2 | Present | 100 | 100 | 82 |
| Example 3 | Present | 20 | 20 | 81 |
| Example 4 | Absent | — | 20 | 81 |
| Example 5 | Present | 400 | 380 | 80 |
| Comparative | Absent | — | 0 | 74 |
| Example | | | | |

For all of the batteries of Examples 1 to 5 each having the bent portion provided in the negative electrode, the capacity retention was greater than or equal to 80%. On the other hand, for the battery of Comparative Example not having a bent portion, the capacity retention was 74%, being a lower value of the capacity retention than those of the batteries of Examples 1 to 5. It is understood that since providing the bent portion in the negative electrode was able to restrain the negative electrode from coming close to the starting end side of the positive electrode during the cycles, such excellent cycle characteristics were obtained.

### REFERENCE SIGNS LIST

10 Battery, 11 Positive electrode, 11a Starting end, 12 Negative electrode, 13 Separator, 14 Electrode assembly, 16 Exterior can, 17 Sealing assembly, 18, 19 Insulating plate, 20 Positive electrode lead, 21 Negative electrode lead, 23 Sealing plate, 23a Through hole, 24 Lower vent member, 25 Insulating member, 26 Upper vent member, 27 Terminal cap, 27a Through hole, 28 Gasket, 30 Tubular portion, 34 Grooved portion, 38 Shoulder, 41 Positive electrode core, 42 Positive electrode mixture layer, 45 Peripheral edge, 51 Negative electrode core, 52 Negative electrode mixture layer, 58 Facing portion that faces the starting end of the positive electrode on the negative electrode, 60 Non-facing portion, 60a Outer winding surface of the non-facing portion, 61 Negative electrode mixture layer formation portion, 61a Outer winding surface of the negative electrode mixture layer formation portion, 69 Recess, 71 Bent portion, 71a Outer winding surface of the bent portion, 71b End of the bent portion on the outer winding side on the outer winding surface, 71c End of the bent portion on the inner winding side on the outer winding surface, 75 Resin tape.

1. A cylindrical non-aqueous electrolyte secondary battery, comprising:
an electrode assembly having a positive electrode and a negative electrode wound via a separator;
a non-aqueous electrolyte; and
an exterior can that houses the electrode assembly and the non-aqueous electrolyte, wherein
the negative electrode has a bent portion that is bent to an inner winding side, more on a winding starting side than a facing portion that faces a starting end of the positive electrode on the inner winding side of the starting end.

2. The cylindrical non-aqueous electrolyte secondary battery according to claim 1, wherein the bent portion is positioned more on a winding finishing side than a position of ¼ rounds from the facing portion to the winding starting side on the negative electrode.

3. The cylindrical non-aqueous electrolyte secondary battery according to claim 1, wherein a difference in a radial direction of the electrode assembly between an end of the bent portion on a winding finishing side on an outer winding surface and an end of the bent portion on the winding starting side on the outer winding surface is greater than or equal to 20 μm.

4. The cylindrical non-aqueous electrolyte secondary battery according to claim 1, comprising a resin tape that is pasted on an outer winding surface of a non-facing portion that does not face the positive electrode on the negative electrode.

5. The cylindrical non-aqueous electrolyte secondary battery according to claim 4, wherein a thickness of the resin tape is greater than or equal to 20 μm and less than or equal to 400 μm.
